(19) United States
(12) Patent Application Publication
(10) Pub. No.: US 2025/0333242 A1
(43) Pub. Date: Oct. 30, 2025

(54) CONCEALED TRASH CAN SYSTEM

(71) Applicants: Tina Daigle, Port Colborne (CA); Yves Bonneau, Port Colborne (CA)

(72) Inventors: Tina Daigle, Port Colborne (CA); Yves Bonneau, Port Colborne (CA)

(21) Appl. No.: 18/904,173

(22) Filed: Oct. 2, 2024

Related U.S. Application Data
(60) Provisional application No. 63/638,640, filed on Apr. 25, 2024.

(51) Int. Cl. B65F 1/14; A47B 77/18; B65F 1/16

(52) U.S. Cl. CPC B65F 1/1426; A47B 77/18; B65F 1/141; B65F 1/1615; B65F 2210/148

(57) ABSTRACT

A concealed trash can system is provided comprised of a primary door with a front and rear surface, where the front surface includes a secondary door that can open to provide access to an interior trash receptacle. The rear surface is equipped with a fastener that securely supports the trash receptacle in a suspended position. The fastener may include various types of mounting brackets and reciprocating fastening mechanisms, such as a male and female lip, which allows for the removable attachment of the receptacle. The secondary door, which is hinged to the front surface, can be opened to insert trash into the receptacle through an opening in the primary door and may also feature an automatic locking mechanism to prevent access by children or pets. Additionally, the positioning of the secondary door at a height beyond the reach of young children enhances safety.

### CROSS-REFERENCE TO RELATED APPLICATION

The present application claims priority to, and the benefit of, U.S. Provisional Application No. 63/638,640, which was filed on Apr. 25, 2024, and is incorporated herein by reference in its entirety.

### FIELD OF THE INVENTION

The present invention relates generally to the field of trash receptacle systems. More specifically, the present invention relates to a concealed trash can system with a trash receptacle that can be suspended from the rear surface of a door, wherein the receptacle can be accessed from the front surface of the door via a secondary door. Accordingly, the present disclosure makes specific reference thereto. Nonetheless, it is to be appreciated that aspects of the present invention are also equally applicable to other like applications, devices, and methods of manufacture.

### BACKGROUND

Trash and recycling receptacles in homes are frequently placed in high-traffic areas such as the kitchen, bathroom, laundry room, and other common spaces where they are easily accessible and conveniently located for everyday use. However, this accessibility often comes with unintended consequences, particularly in households with pets and young children. In these environments, traditional trash bins present a significant challenge. Dogs, cats, and small children are naturally curious and can easily get into the garbage, creating a mess that can be both frustrating and dangerous.

Pets, for instance, may rummage through the trash looking for food scraps. Unfortunately, many of the items commonly discarded in household waste, such as chicken bones, chocolate, or certain food packaging, can be extremely hazardous to animals. Chicken bones, in particular, are notorious for splintering and can cause serious internal injuries, choking, or even death if ingested. Ingesting other dangerous substances like spoiled food, coffee grounds, or small plastic items can lead to poisoning, intestinal blockages, or other health emergencies that require immediate veterinary care, incurring both emotional distress and financial costs.

For families with young children, the problem is equally concerning. Small children are naturally drawn to exploring their surroundings, and an open or easily accessible trash bin can be a source of endless fascination. However, this can lead to dangerous situations where children come into contact with unsanitary waste. Dirty diapers, discarded food, or sharp objects like broken glass and metal can pose significant health and safety risks. A child digging through a trash bin may not only spread garbage throughout the house, creating an unsightly mess, but they can also ingest or be exposed to harmful bacteria, leading to illness or infection. This scenario often results in the need for immediate baths to clean the child and a thorough cleaning of the contaminated area to restore hygiene, which can be both time-consuming and labor-intensive for parents.

Furthermore, the need to constantly monitor and restrict access to trash bins adds an extra layer of stress to the daily routine of managing a household. The anxiety of potentially finding a pet in distress or a child playing with harmful waste disrupts the peace of mind that every homeowner seeks to maintain. This constant vigilance can detract from the overall enjoyment of time spent at home, especially for those who are already balancing multiple responsibilities, such as work, child-rearing, and household management.

Therefore, there exists a long-felt need in the art for an improved trash can system. There also exists a long-felt need in the art for a concealed trash can system. More specifically, there exists a long-felt need in the art for a concealed trash can system that keeps trash securely stored away from pets and children. Further, there exists a long-felt need in the art for a concealed trash can system that keeps trash securely stored away from pets and children wherein the system does not detract from the aesthetics of the space the system is installed in.

The subject matter disclosed and claimed herein, in one embodiment thereof, comprises a concealed trash can system. The device is comprised of a primary door with a front and rear surface, where the front surface includes a secondary door that can open to provide access to an interior trash receptacle. The rear surface is equipped with a fastener that securely supports the trash receptacle in a suspended position. The fastener may include various types of mounting brackets and reciprocating fastening mechanisms, such as a male and female lip, which allow for the removable attachment of the receptacle. The secondary door, which is hinged to the front surface, can be opened to insert trash into the receptacle through an opening in the primary door and may also feature an automatic locking mechanism to prevent access by children or pets. Additionally, the positioning of the secondary door at a height beyond the reach of young children enhances safety, and the door can be equipped with various types of handles to facilitate easy opening and closing.

In this manner, the concealed trash can system of the present invention accomplishes all the forgoing objectives and provides an improved trash can system. More specifically, the system keeps trash securely stored away from pets and children. Further, the system does not detract from the aesthetics of the space the system is installed in while doing so.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a concealed trash can system. The system is comprised of a door comprised of a front surface comprised of a secondary door and a rear surface comprised of a fastener that removably receives a trash receptacle. In different embodiments, the door may be a door type of any structure such as but not limited to a cabinet, a pantry, or a stand-alone cabinet or other structure door.

The rear surface of said door is comprised of at least one fastener. In one embodiment, the fastener is comprised of a mounting bracket that can be secured to the rear surface via a fastener such as but not limited to a screw, a nail, etc. In the preferred embodiment, the fastener is comprised of a mounting bracket comprised of at least one secondary fastener in the form of a male lip. The fastener engages at least one secondary fastener, which is preferably a female lip, of a trash receptacle to attach the receptacle in a suspended manner from the rear surface.

The fastener is positioned on the rear surface such that the receptacle is positioned behind at least one secondary door of the door. More specifically, the secondary door attaches to the front surface of the door via a hinge such that the door can be opened to allow trash to be inserted inside the receptacle through the door via at least one opening in the door. When finished, the door can then be closed such that the receptacle is inaccessible. In one embodiment, the door may be automatically locked or closed via at least one locking mechanism.

The present invention is also comprised of a method of using the system. First, a system is provided comprised of a door comprised of an opening, a secondary door attached to the door, and a rear surface comprised of a fastener that receives a trash receptacle. Then, a trash receptacle can be secured to the fastener. Then, the door can be opened to allow a user to put a piece of trash into the receptacle through the opening of the door. Finally, the door can be closed to conceal and prevent access to the trash receptacle.

Accordingly, the concealed trash can system of the present invention is particularly advantageous as it provides an improved trash can system. More specifically, the system keeps trash securely stored away from pets and children. Further, the system does not detract from the aesthetics of the space the system is installed in while doing so. In this manner, the concealed trash can system overcomes the limitations of existing trash can systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a concealed trash can system of the present invention in accordance with the disclosed architecture;

FIG. 2 illustrates a perspective view of a rear surface of a door of one potential embodiment of a concealed trash can system of the present invention in accordance with the disclosed architecture;

FIG. 3 illustrates a side view of one potential embodiment of a concealed trash can system of the present invention in accordance with the disclosed architecture;

FIG. 4 illustrates a perspective view of one potential embodiment of a concealed trash can system installed within a stand-alone cabinet of the present invention in accordance with the disclosed architecture; and

FIG. 5 illustrates a flowchart of a method of using one potential embodiment of a concealed trash can system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved trash can system. There also exists a long-felt need in the art for a concealed trash can system. More specifically, there exists a long-felt need in the art for a concealed trash can system that keeps trash securely stored away from pets and children. Further, there exists a long-felt need in the art for a concealed trash can system that keeps trash securely stored away from pets and children wherein the system does not detract from the aesthetics of the space the system is installed in.

The present invention, in one exemplary embodiment, is comprised of a concealed trash can system comprised of a door comprised of a front surface comprised of a secondary door and a rear surface comprised of a fastener that removably receives a trash receptacle. In different embodiments, the door may be a door type of any structure such as but not limited to a cabinet, a pantry, or a stand-alone cabinet or other structure door.

The rear surface of said door is comprised of at least one fastener preferably comprised of a mounting bracket that can be secured to the rear surface via a fastener such as but not limited to a screw, a nail, etc. In the preferred embodiment, the fastener is comprised of a mounting bracket comprised of at least one secondary fastener in the form of a male lip, wherein this fastener engages at least one secondary fastener, which is preferably a female lip, of a trash receptacle to attach the receptacle in a suspended manner from the rear surface.

The fastener is positioned on the rear surface such that the receptacle is positioned behind at least one secondary door of the door. More specifically, the secondary door attaches to the front surface of the door via a hinge such that the door can be opened to allow trash to be inserted inside the receptacle through the door via at least one opening in the door. When finished, the door can then be closed such that the receptacle is inaccessible. In one embodiment, the door may be automatically locked or closed via at least one locking mechanism.

The present invention is also comprised of a method of using the system. First, a system is provided comprised of a door comprised of an opening, a secondary door attached to the door, and a rear surface comprised of a fastener that receives a trash receptacle. Then, a trash receptacle can be secured to the fastener. Then, the door can be opened to allow a user to put a piece of trash into the receptacle through the opening of the door. Finally, the door can be closed to conceal and prevent access to the trash receptacle.

Accordingly, the concealed trash can system of the present invention is particularly advantageous as it provides an improved trash can system. More specifically, the system keeps trash securely stored away from pets and children. Further, the system does not detract from the aesthetics of the space the system is installed in while doing so. In this manner, the concealed trash can system overcomes the limitations of existing trash can systems known in the art.

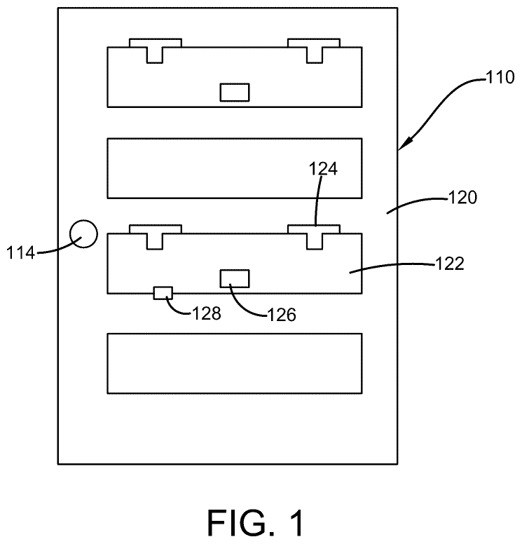

Referring initially to the drawings, FIG. 1 illustrates a front view of one potential embodiment of a concealed trash can system 100 of the present invention in accordance with the disclosed architecture. The system 100 is comprised of a door 110 comprised of a front surface 120 comprised of a secondary door 122 and a rear surface 130 comprised of a fastener 140 that removably receives a trash receptacle 150. In different embodiments, the door 110 may be a door type of any structure such as but not limited to a cabinet (wherein the door 110 is a cabinet door), a pantry (wherein the door 110 is a pantry door), or a stand-alone cabinet or other structure (wherein the door 110 is the front-facing door of said structure). The door 110 may be comprised of at least one handle 114.

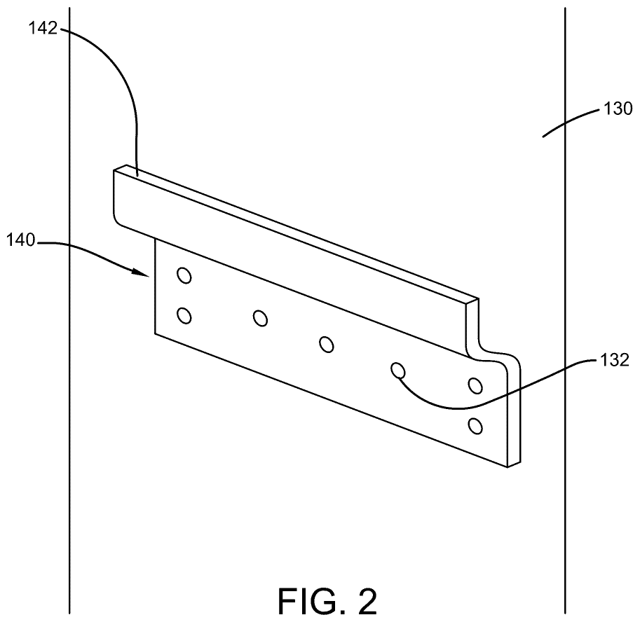

The rear surface 130 of said door 110 is comprised of at least one fastener 140, as seen in FIG. 2. In one embodiment, the fastener 140 is comprised of a mounting bracket that can be secured to the rear surface 130 via a fastener 132 such as but not limited to a screw, a nail, etc. In the preferred embodiment, the fastener 140 is comprised of a mounting bracket comprised of at least one secondary fastener 142 in the form of a male lip. The fastener 142 engages at least one secondary fastener 152, which is preferably a female lip, of a trash receptacle 150 to attach the receptacle 150 in a suspended manner from the rear surface 130. However, it should be appreciated that the fastener 142,152 may be any type of reciprocating fastener type such as but not limited to a tongue fastener and a groove fastener, a hook fastener and a loop fastener, a pair of magnet fasteners, a male fastener and a female fastener, etc. that allow the trash receptacle 150 to removably attach to the fastener 140 (which provides overall support to the receptacle 150).

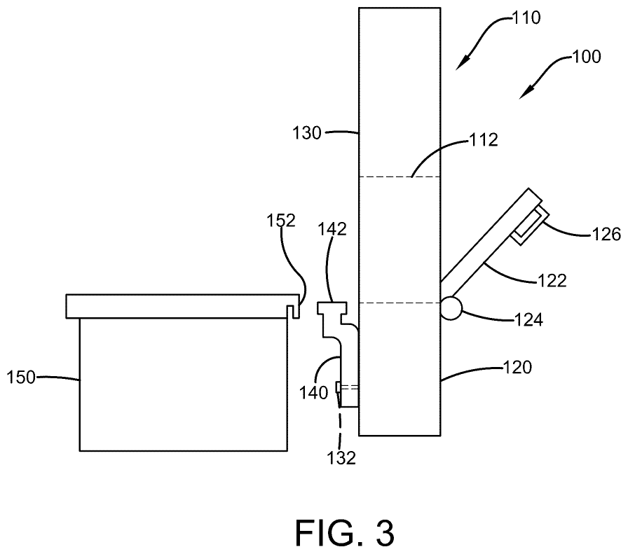

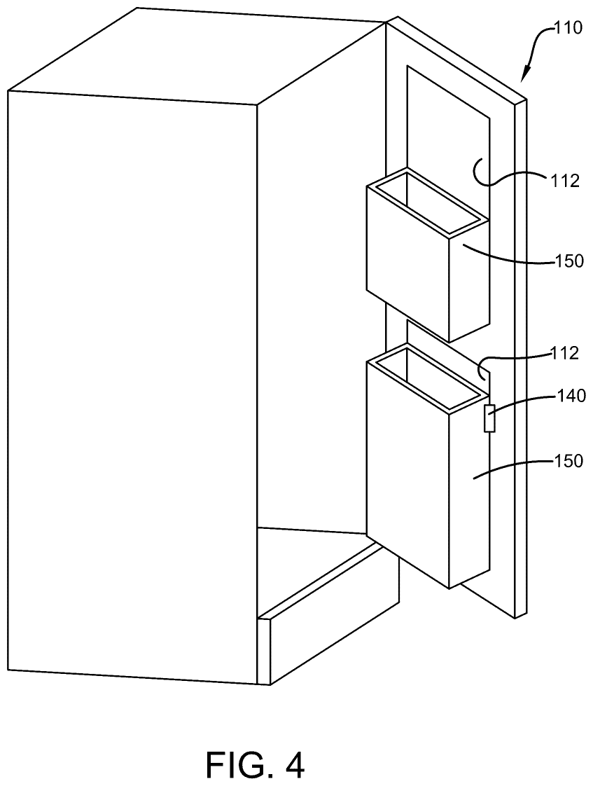

The fastener 140 is positioned on the rear surface 130 such that the receptacle 150 is positioned behind at least one secondary door 122 of the door 110, as seen in FIG. 3 and FIG. 4. More specifically, the secondary door 122 attaches to the front surface 120 of the door 110 via a hinge 124, such as but not limited to a soft-close stopping hinge 124. The door 122 can be opened to allow trash to be inserted inside the receptacle 150 through the door via at least one opening 112 in the door 110. When finished, the door 110 can then be closed such that the receptacle 150 is inaccessible.

In one embodiment, the door 122 may be automatically (or manually) locked closed via at least one locking mechanism 128. The mechanism 128 may be any type of manual or automatic locking mechanism known in the art such as but not limited to a cam lock, a key lock, a latch lock, a barrel bolt lock, a biometric lock, a digital lock, a keypad lock, an RFID lock, a magnetic lock, etc. In this manner, children or pets cannot gain access to the trash receptacle 150 through the door 122. In addition, the suspended position of the receptacle 150 on the door 110 is such that the secondary door 122 is preferably positioned at a height that is not reachable by young children. Opening and closing of the door may be facilitated by at least one handle 126 located on the door 122 of any type, style, and configuration.

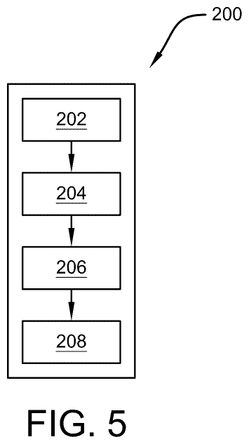

The present invention is also comprised of a method of using 200 the system 100, as seen in FIG. 5. First, a system 100 is provided comprised of a door 110 comprised of an opening 112, a secondary door 122 attached to the door 110, and a rear surface 130 comprised of a fastener 140 that receives a trash receptacle 150 [Step 202]. Then, a trash receptacle 150 can be secured to the fastener 140 [Step 204]. Then, the door 122 can be opened to allow a user to put a piece of trash into the receptacle 150 through the opening 112 of the door 110 [Step 206]. Finally, the door 122 can be closed to conceal and prevent access to the trash receptacle 150 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “concealed trash can system” and “system” are interchangeable and refer to the concealed trash can system 100 of the present invention.

Notwithstanding the forgoing, the concealed trash can system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the concealed trash can system 100 as shown in the FIGS. are for illustrative purposes only, and that many other sizes and shapes of the concealed trash can system 100 are well within the scope of the present disclosure. Although the dimensions of the concealed trash can system 100 are important design parameters for user convenience, the concealed trash can system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A concealed trash can system comprising:
a trash receptacle; and
a door comprised of:
an opening;
a secondary door attached to the door via a hinge; and
a rear surface comprised of a fastener.

2. The concealed trash can system of claim 1, wherein the fastener is comprised of a mounting bracket.

3. The concealed trash can system of claim 1, wherein the fastener is positioned below the opening.

4. The concealed trash can system of claim 1, wherein the door is comprised of a handle.

5. The concealed trash can system of claim 1 further comprised of a locking mechanism.

6. The concealed trash can system of claim 5, wherein the locking mechanism secures the secondary door to the door.

7. The concealed trash can system of claim 1, wherein the secondary door is positioned in front of the opening.

8. The concealed trash can system of claim 1, wherein the door is comprised of a cabinet door or a pantry door.

9. A concealed trash can system comprising:
a trash receptacle comprised of a first fastener; and
a door comprised of:
an opening;
a secondary door attached to the door via a hinge; and
a rear surface comprised of a second fastener, the second fastener comprised of a third fastener.

10. The concealed trash can system of claim 9, wherein the first fastener is comprised of a female lip.

11. The concealed trash can system of claim 9, wherein the second fastener is comprised of a mounting bracket.

12. The concealed trash can system of claim 9, wherein the third fastener is comprised of a male lip.

13. The concealed trash can system of claim 9, wherein the first fastener and the second fastener are comprised of a tongue and groove fastener, a hook fastener and a loop fastener, a pair of magnet fasteners, or a male fastener and a female fastener.

14. The concealed trash can system of claim 9, wherein the secondary door is positioned in front of the opening.

15. The concealed trash can system of claim 14, wherein the trash receptacle is positioned behind the secondary door.

16. The concealed trash can system of claim 9 further comprised of a locking mechanism that secures the secondary door to the door.

17. The concealed trash can system of claim 16, wherein the locking mechanism is comprised of to a cam lock, a key lock, a latch lock, a barrel bolt lock, a biometric lock, a digital lock, a keypad lock, an RFID lock, or a magnetic lock.

18. A method of using a concealed trash can system, the method comprising the following steps:
providing a concealed trash can system comprised of a door comprised of an opening, a secondary door attached to the door, and a rear surface comprised of a fastener that receives a trash receptacle;
securing the trash receptacle to the fastener;
opening the secondary door and placing a piece of trash into the trash receptacle; and
closing the secondary door.

19. The method of using a concealed trash can system of claim 18, wherein the fastener is comprised of a mounting bracket comprised of a male lip.

20. The method of using a concealed trash can system of claim 18, wherein the trash receptacle is comprised of a female lip.
